(19) United States
(12) Patent Application Publication
(10) Pub. No.: US 2015/0163126 A1
(43) Pub. Date: Jun. 11, 2015

(54) METHOD FOR ROUTING DATA TRAFFIC IN A COMMUNICATION NETWORK

(71) Applicants: Konstantinos Samdanis, Dossenheim (DE); Dominique Dudkowski, Wernau (DE)

(72) Inventors: Konstantinos Samdanis, Dossenheim (DE); Dominique Dudkowski, Wernau (DE)

(21) Appl. No.: 14/411,520

(22) PCT Filed: Jun. 28, 2012
(86) PCT No.: PCT/EP2012/062607

§ 371 Date: Feb. 23, 2015

(51) Int. Cl. H04L 12/721; H04L 12/24; H04L 12/707

(52) U.S. Cl. CPC H04L 45/124; H04L 45/24; H04L 41/0668; H04L 41/0659

(57) ABSTRACT

A method for routing data traffic in a communication network having a source entity, a destination entity, and a plurality of routers for routing the data traffic from the source entity to the destination entity according to link-state-routing according to a shortest-path-first-algorithm, includes transmitting load information of the at least one data traffic interface to a routing management entity and control information, about a low load period of the at least one data traffic interface to the first router (DR), wherein a low load period is related to a data traffic interface of the first router (DR). The method further includes switching, by the first router (DR), into a dosing-state as an energy-saving state during the low load period, and issuing, by the first router (DR) before entering the dosing-state, an operational state message.

### CROSS-REFERENCE TO RELATED APPLICATIONS

This application is a U.S. National Phase application under 35 U.S. §371 of International Application No. PCT/EP2012/062607 (WO 2014/000804 A1), filed on Jun. 28, 2012.

### FIELD

The invention relates generally to methods and systems for routing data traffic in a communication network, particularly to link-state routing of data traffic in a communication network, and more specifically to methods and systems for a.

### BACKGROUND

The shortest-path-first-algorithm and its open deployment protocol version named open-shortest-path-first (OSPF), is a link state routing protocol, wherein each router monitors the operational states of links attached. The link state of the router is periodically advertised or if the network topology was changed via so-called state link advertisements (SLA) which are flooded reaching all routers within the network. Each router therefore receives information from all other routers and in this way a global routing view of the network is constructed. Routers then compute the shortest path tree towards all other routers. Based on such shortest path calculations the routers create routing tables and enter the corresponding next hop router for each destination.

Increasing costs for energy also affects networks, especially the operation of routers. Different solutions have been presented to address this problem, i.e. reducing the energy consumption of routers in certain cases.

In the non-patent literature of M. Gupta, S. Singh, “Greening of the Internet”, ACM SIGCOMM, Karlsruhe, August 2003, different solutions to power-off routers or switches and network interfaces are proposed identifying the further problem of a resulting protocol modification thereof related to the shortest-path-first-algorithm and to distinguish a powered-off router from being faulty. Further consistency of routing topology for example among all networks routers has to be ensured.

In the non-patent literature of R. Bolla, R. Bruschi, F. Davoli, F. Cucchietti, “Energy Efficiency in the Future Internet: A Survey of Existing Approaches and Trends in Energy Aware Fixed Network Infrastructures”, IEEE Communications Surveys and Tutorials, Vol. 13, No. 2, 2011, algorithms are presented for identification of the network equipment to be powered-on and powered-off providing algorithms capable to identify a minimum number of nodes, routers and/or interfaces of routers to remain being powered-on ensuring overall connectivity within the network. In this document so called “energy-aware routing” as well as other heuristics and analytical methods, for example based on linear integer programming LIP are described. For example a centralized algorithm identifies network equipment, in particular interfaces to remain powered-on and signals to power-off Once a component is powered-off a link state advertisement is flooded and a new shortest-path tree is calculated keeping a consistent routing view between all routers. However, a disadvantage is, that this algorithm does not allow to differentiate between dosing or sleeping of router and a failure.

In the non-patent literature of A. Cianfrani, V. Eramo, M. Listanti, M. Polverini, “An OSPF Enhancement for Energy Saving in IP Networks”, IEEE INFOCOM Workshop on Green Communications and Networking, Shanghai, April 2011, routers are powered-off if their traffic routed to them is low provided that their neighbour routers could also route the traffic while ensuring a certain service quality, for example based on Quality of Service QoS. Routers are divided into two groups, namely one group with routers with routing tables remaining without changes and a second group that import routing tables of their neighbour routers. Therefore a shortest-path tree recalculation is not performed but instead a shortest-path tree exchange and synchronization. This avoids state link advertisements when powering-off routers allowing a cyclic sleeping mode. A disadvantage is, that the routers may only sleep for a specified short period before they have to be woken up to respond to so called HELLO-messages to ensure that the router sending the HELLO-message does not qualify the temporary sleeping router receiving the message as being faulty. This provides a very limited energy saving, since in regular intervals the router has to be powered on and off again wasting a lot of energy just for an indication to be not faulty.

In the non-patent literature of M. Zhang, Yi, B. Liu, B. Zhang, “GreenTE: Power-Aware Traffic Engineering”, IEEE International Conference on Network Protocols (ICNP), Kyoto, October 2010, an additional component operation state is proposed to indicate a sleeping state of a router. In this document routers or more generally network components in such a sleeping state cannot handle data traffic but may handle data traffic if the network component is woken up, for example due to a quality of service QoS degradation. However, one of the disadvantages is, that this requires modifications on the routing protocol design. Another option without protocol modifications is to adopt protocol specific parameters to apply a sleeping state including in particular a larger message exchange time period of a HELLO protocol to ensure that links to sleeping routers are not qualified as faulty. However, this may create an inconsistent network topology view in case of a failure or routing loops due to lack of synchronization when metric changes occur. Another option mentioned in this document is to wake up routers and specifically their interfaces in the sleeping state on demand to process incoming data packets. However, this results in only very small energy savings. Another disadvantage is, that when waking up interfaces on demand a certain time is required so routers should only power off interfaces provided that they are idle for a minimum time period to avoid packet loss.

Another approach is shown in the non-patent literature of Y. Wang, E. Keller, B. Biskeborn, J. Van der Merwe, J. Rexford, “Virtual Routers on the Move: Live Router Migration as a Network Management Primitive”, ACM SIGCOMM, Seattle, August 2008, as well as in the non-patent literature of R. Bolla, R. Bruschi, A. Cianfrani, M. Listanti, “Introducing Standby Capabilities into Next-generation Network Devices”, ACM PRESTO, Philadelphia, November 2010. Both documents try to provide energy efficient routing via virtualization of the network where the physical resources are decoupled from the higher network infrastructure. The first document uses router migration, so called VROOM (Virtual Routers On the Move) and in this document virtual routers can move from one physical router to another without disrupting ongoing flows or changing the routing topology preventing costly routing updates and shortest-path tree convergence delays. The second document uses interface migration within the same router. Although able to save energy virtualization may introduce changes on the costs of network path since the migration from one physical resource to another may affect the costs of the network path. To avoid changes on the costs routing updates similar to the case of a network topology change have to be implemented. Otherwise network path information would be incorrect. Alternatively additional mechanisms or procedures have to be implemented to ensure that selected network components receiving a migration of routers or interfaces would not affect the costs or the original path.

In US 2010/0329276 A1 a method is described based on the utilization of a link at a network forwarding device and determining a weight for the link with respect to energy. Such weight is transmitted to at least one node adjacent in the network to the network forwarding device and based on the transmitted weight, forwarding is determined. This document shows therefore energy-aware link weights based on resourced utilization.

In the non-patent literature of S. S. W. Lee, P-K. Tseng, A. Chen, “Link Weight Assignment and Loop-free Table Update for Link Sate Routing Protocols in Energy-Aware Internet”, Elsevier Future Generation Computer systems, Vol. 28, No.2, February 2012, further approaches to resolve routing inconsistencies during topology alternations are described when a router and link are powered-off proposing a distributed loop-free routing update scheme to guarantee loop-free packet forwarding when the network topology changes.

### SUMMARY

In an embodiment, the present invention provides a method for routing data traffic in a communication network, comprising a source entity, a destination entity, and a plurality of routers for routing the data traffic from the source entity to the destination entity, wherein the data traffic is routed according to link-state-routing and wherein a first router of the plurality of routers has different operational states, one being an energy saving state, wherein the energy saving state is related to at least a data traffic interface of the first router, the method comprising transmitting, by the first router, load information of the at least one data traffic interface to a routing management entity, transmitting, by the routing management entity, information about a low load period of the at least one data traffic interface to the first router, wherein a low load period is related to a data traffic interface of the first router, switching, by the first router, into a dosing-state as an energy-saving state during the low load period, and issuing, by the first router before entering the dosing-state, an operational state message for at least one neighbour router including information about the at least one router with the at least one data traffic interface entering the dosing-state.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 depicts an embodiment of a system according to the present invention.

### DETAILED DESCRIPTION

Embodiments of the invention relate to methods for routing data traffic in a communication network, comprising a source entity, a destination entity, and a plurality of routers for routing the data traffic from the source entity to the destination entity, wherein the data traffic is routed according to link-state-routing, preferably according to a shortest-path-first-algorithm and wherein at least one of the routers has different operational states, one being an energy saving state, wherein the energy saving state is related to at least a data traffic interface of the at least one router.

Embodiments of the invention relate also to systems for routing data traffic in a communication network, comprising a source entity, a destination entity, and a plurality of routers for routing the data traffic from the source entity to the destination entity, wherein the data traffic is routed according to link-state-routing, preferably according to a shortest-path-first-algorithm and wherein at least one of the routers has different operational states, one being an energy saving state, wherein the energy saving state is related to at least a data traffic interface of the at least one router.

Although applicable in general to link-state-routing of data traffic in the communication network the present invention will be described by routing according to shortest-path-first-algorithm.

According to an embodiment of the invention, it is an objective to provide a method and a system for routing data traffic in a communication network which enable energy savings in the communication network.

According to a further embodiment of the invention, it is an objective to provide a method and a system for routing data traffic in a communication network which provides an energy-efficient routing of data traffic in the communication network.

According to a further embodiment of the invention, it is an objective to provide a method and a system for routing data traffic in a communication network which provide an operational state from where routers and interfaces may be woken up in a short time.

According to a further embodiment of the invention, it is an objective to provide a method and a system for routing data-traffic in a communication network minimizing network topology alternations to be handled without the need of link state advertisements.

According to a further embodiment of the invention, it is an objective to provide a method and a system for routing data-traffic in a communication network minimizing link state updates, in particular minimize the shortest-path tree recalculations.

According to a further embodiment of the invention, it is an objective to provide a method and a system for routing data traffic in a communication network which provide a reliable assessment whether network components in an energy saving-like state need to be woken up.

The method is provided for routing data traffic in a communication network, comprising a source entity, a destination entity, and a plurality of routers for routing the data traffic from the source entity to the destination entity, wherein the data traffic is routed according to link-state-routing, preferably according to a shortest-path-first-algorithm, and wherein at least one of routers has different operational states, one being an energy-saving state, wherein the energy-saving state is related to at least a data traffic interface of the at least one router.

The method is provided that is characterized in that the at least one router transmits load information of the at least one data traffic interface to a routing management entity, that the routing management entity transmits information preferably control information about a low load period of the at least one data traffic interface to the at least one router, wherein a low load period is related to a data traffic interface of the at least one router, that the at least one router switches into a dosing-state as energy-saving state during the low load period and that the at least one router before entering the dosing-state issues an operational state message for at least one neighbour router including information about the at least one router with the at least one data traffic entering the dosing-state.

The system is provided for routing data traffic in a communication network comprising a source entity, a destination entity, and a plurality of routers for routing the data traffic from the source entity to the destination entity, wherein the data traffic is routed according to link-state routing, preferably according to the shortest-path-first-algorithm, and wherein at least one of routers has different operational states, one being an energy-saving-state, wherein the energy-saving-state is related to at least a data traffic interface of the at least one router.

The system is provided that is characterized in that the at least one router is configured to be operable to transmit load information of the at least one data traffic interface to a routing management entity, that the routing management entity is configured to be operable to transmit information preferably control information about a low load period of the at least one data traffic interface to the at least one router, wherein a low load period is related to a data traffic interface of the at least one router, that the at least one router is configured to be operable to switch into a dosing-state as energy-saving-state during the low load period and that the at least one router is configured to be operable to issue before entering the dosing-state an operational state message for at least one neighbour router including information about the at least one router with the at least one data traffic interface entering the dosing-state.

The term “router” means preferably in the description, in particular in the claims a network component for routing traffic.

The term “low load period” means preferably in the description, in particular in the claims a load on a network interface being below a predefined threshold. Such a threshold may be determined statistically by determining average load on that network interface. The threshold may be defined via a certain percentage of that average.

The term “update cost” means in the description, in particular in the claims costs associated with routing updates, e.g. with the propagation of the state link updates (SLA) and/or with network route recalculations on individual routers.

The term “dosing” in connection with an operational state means in the description, in particular in the claims an operational state with reduced power consumption compared to a normal operational state while ensuring at least network connectivity and a fast switching between the dosing-state and normal operational state.

The term “link-state-routing” includes routing by associated algorithms like load-based routing, delay-based routing or the like.

According to an embodiment of the invention it has first been recognized that the routing management entity provides an intelligence to reliably instruct routers to enter the dosing-state and back into a fully operational state.

According to an embodiment of the invention it has further been recognized that network topology alternations are kept local providing energy savings because link state advertisements are not required. Thus, reducing update costs.

According to an embodiment of the invention it has even further been first recognized, that the dosing-state provides an operational state, from which the router or interface could recover to a fully operational state within a very short time period.

Further features, advantages and preferred embodiments are described in the following subclaims.

According to an embodiment, the data traffic is routed according to multi-path routing. Multi-path routing enables a more reliable routing: When a router is in a dosing-state and not available for routing a neighbour router may simple use an alternative route to the destination which is stored in each router supporting multi-path routing.

According to a further embodiment the operational state message for neighbour routers is included in a presence message. A presence message, for example a HELLO-message using the HELLO-protocol provides a fast and efficient way not only to detect link faults or router faults for a neighbour router: If the operational state message is included in the presence message, data exchange between neighbour routers for indication of entering a dosing-state is reduced since for example only one message header may be used.

According to a further embodiment a router comprises a routing table, wherein the routing table includes an entry indicating a data traffic interface being in the dosing-state. Such an entry enables a fast and easy wakeup of data traffic interfaces or a router being in the dosing-state as well as an easy access to this information by the router itself

According to a further embodiment the entry indicating a data-traffic interface being in the dosing-state is removed when a fault of a router comprising this interface is indicated. This provides a more reliable information concerning the operational state of a router respectively the corresponding interface. For example if the fault would be detected and the entry would not be removed misleading information about the operational state of the router would be a consequence.

According to a further embodiment a routing management entity, preferably a router itself determines entries for aggregating data traffic. One of the advantages is that running of additional algorithms to aggregate traffic is not necessary: The router itself may simply determine entries in its routing table which are popular and can therefore be used for aggregating traffic. An advantage of a routing management entity determining the entries may provide more complex algorithms to determine entries. Further, the routers may be required to have lesser functionality resulting in reduced costs for operating the routers.

According to a further embodiment the neighbour router acts as proxy for the at least one router being in the dosing-state upon receiving the operational state message. A proxy router allows hiding the power-saving or energy-saving state in form of the dosing-state from the remaining network components especially routers. Another advantage is, that the proxy router determines routes for bypassing the router in the dosing-state allowing efficient data routing without additional packet loss.

According to a further embodiment the neighbour router upon receiving of the operational state message and before acting as proxy acquires information about alternative network paths for bypassing the at least one router in the dosing-state. This enables the neighbour router to obtain network topology information and resolve routing loops.

According to a further embodiment information about alternative network paths is acquired by adoption of multi-path routing and/or on demand when a data traffic interface of a router is in the dosing-state. Acquiring information by adoption of multi-path routing allows a very fast bypassing of routers with interfaces being in the dosing-state, since alternative paths are already available. One of the advantages of acquiring information about alternative network paths on demand is, that alternative path information is only acquired when needed thus saving resources in routers.

According to a further embodiment the router acting as proxy performs source routing, loose source routing and/or IP-to-IP encapsulation. When performing source routing the proxy router inserts into a data packet the entire route towards the destination forcing the data packets to be routed along that route and bypassing conventional hop-by-hop routing. When performing loose source routing the proxy router specifies only a single router or a subset of routers to the destination. When performing IP-to-IP encapsulation the proxy router encapsulates data packets to be routed to the destination towards a specified intermediate destination between the router acting as proxy and the destination.

According to a further embodiment when performing loose source routing and/or IP-to-IP encapsulation an anchor router is identified towards the destination entity for providing shortest-path routing from the anchor router to the destination entity and from the router acting as proxy to the anchor router. An anchor router together with the router acting as proxy and routing according to the shortest-path-principle allows an efficient bypassing of interfaces of routers being in the dosing-state reducing routing complexity.

According to a further embodiment the anchor router is determined by the router acting as proxy, preferably wherein the router acting as proxy compares at least two network paths, wherein one network path is an ideal network path from the source entity to the destination entity considering routers with interfaces being in dosing-states and one network path including the router acting as proxy and bypassing routers with interfaces in the dosing-state and wherein the last router in the direction from the destination entity to the source entity being the same in the at least two network paths is selected as anchor router. Routing from the proxy router towards the selected anchor router and from the selected anchor to the destination could be performed using shortest path routing, which reduce complexity while by-passing routers with interfaces being in the dosing state. At least part of the ideal alternative route is then used providing efficient routing of data traffic in particular from the anchor router to the destination entity.

According to a further embodiment the router acting as proxy maintains prior proxy routing information, preferably a record of the entries of its routing table, before acting as proxy. This enables the router acting as a proxy to provide a router with interfaces being woken up from a dosing-state with current routing information and further provides a fast recovery of the original network topology: When a router with interfaces being in the dosing-state is woken up, the router acting as proxy knows routing database parts which have changed during the dosing-state period and provides information about changed routing information. Only the changed routing information may then be provided to the awakened router, enabling a very fast recovery.

According to a further embodiment a waking-up of an interface of a router being in the dosing-state is performed by the router acting as proxy, preferably wherein the router acting as proxy estimates a potential of the data-traffic to be routed via the remaining network paths and wakes up the interface of the router in the dosing-state if quality of service of a data-traffic session via the remaining network paths is not fulfilled. This provides criteria based on the quality of service violation policies. For example the router acting as proxy once it receives a data packet belonging to a session within a certain quality of service level, the router acting as proxy may estimate the quality of service according to the remaining different network paths from the source to the destination. If the level of quality of service on remaining active network paths is below a certain threshold the router acting as a proxy awakens the router with interfaces being in the dosing-state to ensure quality of service above the threshold by routing additionally and/or alternatively via the awakened router. It is also possible to provide an awakening of routers with interfaces being in the dosing-state by a certain centralized entity in the network for example the router acting as proxy may be a server-based router providing a centralized proxy for a certain sub-network.

According to a further embodiment information exchange about interfaces of routers being in a dosing-state is performed by including corresponding information in the presence messages between routers preferably routers acting as proxy. This minimizes data traffic between routers acting as proxy and further of presence messages between all routers: If routers acting as proxy exchange information about routers in a dosing-state, these routers may not send the presence messages to these routers to determine itself whether the router is in a dosing-state or not. Waking up these routers particularly their interfaces may be restricted to corresponding direct neighbour routers and performed only when necessary. This also provides further efficient routing avoiding loops. In addition, once a data packet is received by a router that has no alternative network path to route the data packet to the destination entity except the one from which it has received, it simply wakes up an appropriate router to forward the data packet.

According to a embodiment of the system according to claim 16, the neighbour router is configured to be operable to act as a proxy for the at least one router being in the dosing-state upon receiving the operational state message. A proxy router enables to hide the power-saving or energy-saving state in form of the dosing-state from the remaining network routers. Another advantage is, that the proxy router determines routes for bypassing the router in the dosing-state allowing efficient data routing without packet loss.

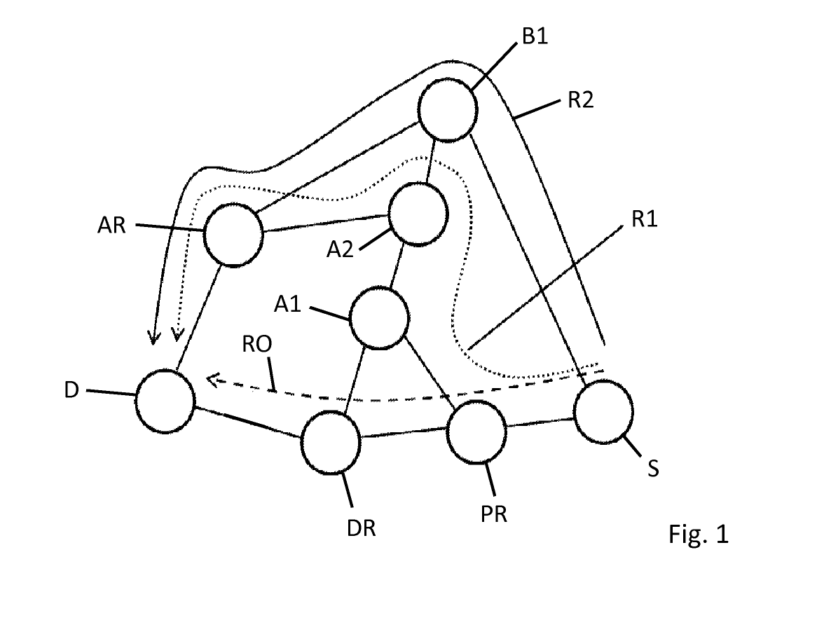

FIG. 1 shows a schematic view of a system for routing according to proxy-based routing. Data packets from a source S are routed via router PR and router DR to the destination D. Assuming now that the router DR is a router with interfaces in the dosing-state, the original route RO from the source S to the destination D cannot be used anymore. The neighbour router DR informs the neighbor router PR about its entry into the dosing-state. The router PR acts then as proxy being responsible for providing an alternative route from the—now called—proxy router PR to the destination D bypassing the dosing-router DR via further routers A1, A2 and AR. However, an alternative route R2 via routers B1 and AR from the source S to the destination D may also exist, the route from the proxy router PR via routers A1, A2 and AR being non-optimal. Such a scenario as described above is applicable for source routing or IP-to-IP encapsulation.

When using loose source routing the route from the source S to the destination D is not specified in its entirety. The use of loose source routing requires an identification of at least one intermediate router on the network path between the source S and the destination D. This intermediate router acts as an anchor router denoted with reference sign AR in the sense that both IP-to-IP encapsulation and loose source routing may use shortest-path-routing towards the anchor router AR and from that anchor router AR towards the destination D. The anchor router AR is identified by the proxy router PR by comparing the path from itself, i.e. the proxy router PR to the destination D without using the router DR in the dosing state and the network path from the destination D to the source S (ideal alternative route denoted with reference sign R2). Initiating from the destination D the proxy router PR compares these two network paths on a node-link basis. The last node towards the source S from the destination D being identical in both network paths is selected as anchor router AR. The first network path from the proxy router PR to the destination D is via routers A1, A2 and AR and the ideal alternative route R2 from the destination D is via the routers AR and B1. The router AR is identical in both network paths. Therefore the router AR is selected as anchor router. If for example another router in a dosing-state is included within the network path from the source S via proxy router PR and routers A1, A2 and AR to the destination D a further proxy router assigned to the further dosing-router is responsible for determining a further anchor router. The network path is then amended accordingly by the further proxy router and again an anchor router is determined.

If the network path requires a certain level of quality of service the further proxy router may check whether the quality of service level is still provided considering also further network path alternations. If the quality of service level is below a certain threshold routers in a dosing state are being awakened. The proxy router PR updates the router in the dosing-state once the router DR in the dosing-state or dosing router is awake again with routing information which has changed during the time period in the dosing-state. The proxy router PR maintains a record of the network entries that have changed from the time the proxy router PR became a proxy. When the dosing-router DR is awakening the proxy router PR knows the routing data-base parts which have changed during the time in the dosing-state. These parts are provided to the awakening router DR, so that the awakening router DR recovers rapidly the altered network topology. In case that a dosing-router DR is awakened because of an urgent need to forward data traffic information where to forward such data traffic may also provided by the proxy router PR until the routing table of the awakening router DR is fully recovered by the information provided by the proxy router PR.

The proxy router PR may—as described above—once it receives a data packet belonging to a session with a certain quality of service level, estimate the quality of service according to different paths from the proxy router PR to the destination D bypassing the router DR in the dosing state. If such a quality of service level on these different paths is below a certain threshold then the proxy router PR awakens the router in the dosing-state DR or its corresponding interfaces to ensure the quality of service level. Such a proxy router PR may also be determined networkwide in a centralized—server based architecture.

In order to avoid network routing loops, i.e. a data packet is received on a router and this router has no alternative path than to route the data packet back to the sending router the proxy router PR wakes up the dosing router DR respectively the corresponding interface to forward the data packet.

In summary the present invention provides an efficient energy usage within a data communication network. A further advantage is that update costs for providing sleeping or dosing on specific routers and/or interfaces is minimized. A further advantage is that a rapid awakening of a router and/or interface is provided.

Further the present invention manages the energy efficiency of in particular open shortest-path-first routing domain by using either multi-path energy aware routing or proxying. The present invention reduces the routing overhead related with energy saving via updating dosing-routers based on local information. Dosing states are introduced for routers and information about the dosing-states is communicated between neighbour routers and is used to achieve energy saving via multi-path routing. The present invention further provides proxy functionality to a neighbour router hiding a dosing of a router. The present invention further may use source routing or IP-to-IP encapsulation to bypass conventional routing. A router keeps further track of network topology changes on behalf of a dosing router. The present invention further manages dosing states of routers in particular open-shortest-path-first routers based on traffic conditions and service level agreements of the underlying network.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and

1. A method for routing data traffic in a communication network, comprising a source entity, a destination entity, and a plurality of routers for routing the data traffic from the source entity to the destination entity, wherein the data traffic is routed according to link-state-routing and wherein first router of the plurality of routers has different operational states, one being an energy saving state related to at least a data traffic interface of the first router, the method comprising:
transmitting, by the first router, load information of the at least one data traffic interface to a routing management entity;
transmitting, by the routing management entity, about a low load period of the at least one data traffic interface to the first router, wherein a low load period is related to a data traffic interface of the first router;
switching, by the first router, into a dosing-state as an energy-saving state during the low load period, and
issuing, by the first router before entering the dosing-state, an operational state message for at least one neighbour router including information about the at least one router with the at least one data traffic interface entering the dosing-state.

2. The method according to claim 1, wherein the data traffic is routed according to multi-path routing.

3. The method according to claim 1, wherein the operational state message for the at least one neighbour router is included in a presence message.

4. The method according to claim 1, wherein at least one router of the plurality of routers comprises a routing table, wherein the routing table includes an entry indicating a data-traffic interface being in the dosing-state.

5. The method according to claim 4, wherein the entry indicating a data-traffic interface being in the dosing-state is removed when a fault of at least one of the plurality of routers comprising the interface is indicated.

6. The method according to claim 4, wherein a routing management entity determines entries for aggregating data traffic.

7. The method according to claim 1, wherein upon receiving the operational state messageₛ the at least one neighbour router acts as proxy for the at least one neighbour router being in the dosing-state.

8. The method according to claim 7, wherein the at least one neighbour router, upon receiving the operational state message and before acting as proxy, acquires information about alternative network paths for bypassing the first router in the dosing-state.

9. The method according to claim 8, wherein information about alternative network paths is acquired by adoption of multi-path routing and/or on demand when a data-traffic interface of at least one router of the plurality of routers is in the dosing-state.

10. The method according to claim 7, wherein the at least one neighbour router acting as proxy performs at least one of source routing, loose source routing, and IP-to-IP encapsulation.

11. The method according to claim 10, wherein when performing loose source routing and/or IP-to-IP encapsulation,. an anchor router of the plurality of routers is identified towards the destination entity for providing shortest path routing from the anchor router to the destination entity and from the at least one neighbour router acting as proxy to the anchor router.

12. The method according to claim 11, wherein the anchor router is determined by the at least one neighbour router acting as proxy, wherein the at least one neighbour router acting as proxy compares at least two network paths, wherein one network path is an ideal alternative network path from the source entity to the destination entity considering routers with interfaces in dosing-states and one network path including the at least one neighbour router acting as proxy and bypassing the first router with interfaces in the dosing-state, and wherein the anchor router is the last router in a direction from the destination entity to the source entity being the same in the at least two network paths.

13. The method according to claim 7, wherein the at least one neighbour router acting as proxy maintains prior proxy routing information, preferably a record of the entries of its routing table, before acting as proxy.

14. The method according to claim 7, wherein a waking-up of an interface of the first router being in the dosing-state is performed by the at least one neighbour router acting as proxy.

15. The method according to claim 7, wherein information exchange about interfaces of the first router being in a dosing-state is performed by including corresponding information in the presence messages between routers of the plurality of routers.

16. A system for routing data traffic in a communication network, comprising;
a source entity;
a destination entity; and
a plurality of routers for routing the data traffic from the source entity to the destination entity according to link-state-routing, according to a shortest-path-first-algorithm, and wherein at least one of the plurality of routers is a first router that has different operational states, one being an energy-saving state, wherein the energy-saving state is related to at least a data traffic interface of the first router,
wherein the first router is configured to be operable to transmit load information of the at least one data traffic interface to a routing management entity,
wherein the routing management entity is configured to be operable to transmit information preferably control information about a low load period of the at least one data traffic interface to the first router, wherein a low load period is related to a data traffic interface of the first router,
wherein the first router is configured to be operable to switch into a dosing-state as an energy-saving state during the low load period, and
wherein the first router is operable to issue, before entering the dosing-state, an operational state message for at least one neighbour router including information about the first router with the at least one data traffic interface entering the dosing-state.

17. The system according to claim 16, wherein the at least one neighbour router is configured to be operable to act as proxy for the first router being in the dosing-state upon receiving the operational state message.

18. The method according to claim 1, wherein the data traffic is routed according to a shortest path first algorithm.

19. The method according to claim 1, wherein the information transmitted by the routing management entity includes control information.

20. The method according to claim 6, wherein the routing management entity is one of the plurality of routers.
